(19) United States
(12) Patent Application Publication
(10) Pub. No.: US 2015/0289556 A1
(43) Pub. Date: Oct. 15, 2015

(54) STAMPING DEVICE AND METHOD TO IMPRINT PICTURES, DESIGNS AND TEXT INTO MILK FROTH OF CAPPUCINO, CAFÉ LATTE AND OTHER COFFEE DRINKS

(71) Applicant: Lutz Hornischer, Berkeley, CA (US)

(72) Inventor: Lutz Hornischer, Berkeley, CA (US)

(21) Appl. No.: 14/686,781

(22) Filed: Apr. 15, 2015

Related U.S. Application Data
(60) Provisional application No. 61/979,869, filed on Apr. 15, 2014.

(51) Int. Cl. A23P 1/10; A23F 5/00; A47J 31/44

(52) U.S. Cl. CPC A23P 1/10; A47J 31/4496; A23F 5/00

(57) ABSTRACT

A stamping device and method to imprint designs, patterns, text or images into the milk froth of café latte, cappuccino or other espresso drinks. The invention comprises of a handle that is attached to a steel wire that is bent according to the design or motive. The surface of the steel wire is roughened up so it can hold liquid coffee that gets released into the milk foam during the stamping process.

### SUMMARY

A stamp to easily imprint a picture, icon or text into the milk froth of a cup of cappuccino, café latte or other espresso drink by stamping liquid coffee into the surface. The coffee imprint created by the stamp delivers a more personalized, fun and emotional coffee experience and makes coffee drinking more pleasurable by adding a visual sensation that complements the taste sensation. The stamp's unique 3-dimensional wire design allows imprinting complex pictures and text that consists of multiple elements (e.g. letters, objects that are not connected to each other) in one stamping process. Additional advantage of the stamp and the stamping process are: The simple wire design makes it easy to build; the selected material make the stamp food-save; easy to clean, easy to use. Further advantages will become apparent from the study of the following descriptions and accompanying drawings and photographs.

### DRAWINGS AND PICTURES

FIG. 1: Perspective side view of a stamp that imprints the word LOVE

FIG. 2: Perspective side view of a stamp that imprints a smiley face

FIG. 3: Perspective side view of stamping process, including bowl with coffee and the cup with milk froth

FIG. 4: Photo of stamp that imprints the word “Love”

FIG. 5: Photo showing the process of imprinting the word into the milk froth

FIG. 6: Photo of a cup of cappuccino with imprinted text

FIG. 7: Photo of stamp that imprints a smiley face and cup of cappuccino that shows imprint

FIG. 8: Photo of stamp that imprint the picture of a smiley face

FIG. 9: Photo showing process of stamping the smiley face

### DETAILED DESCRIPTION

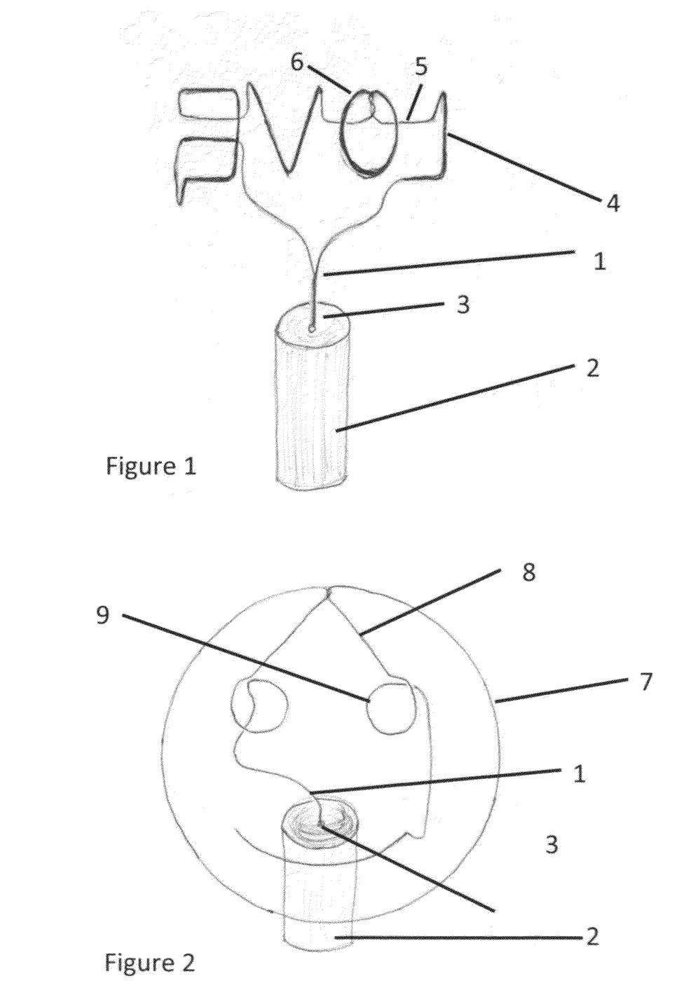

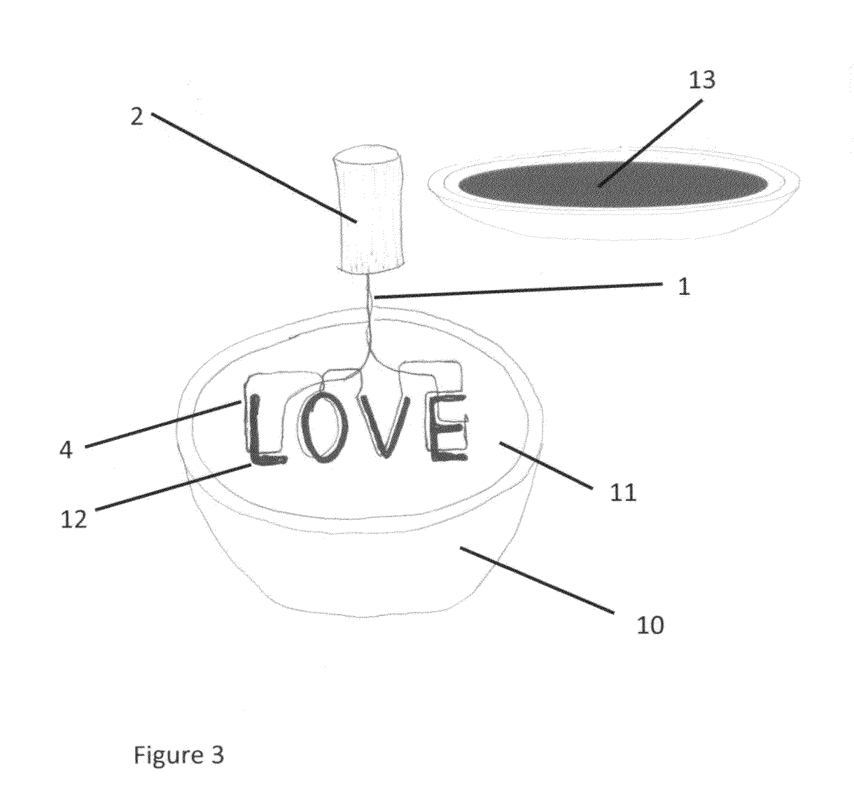

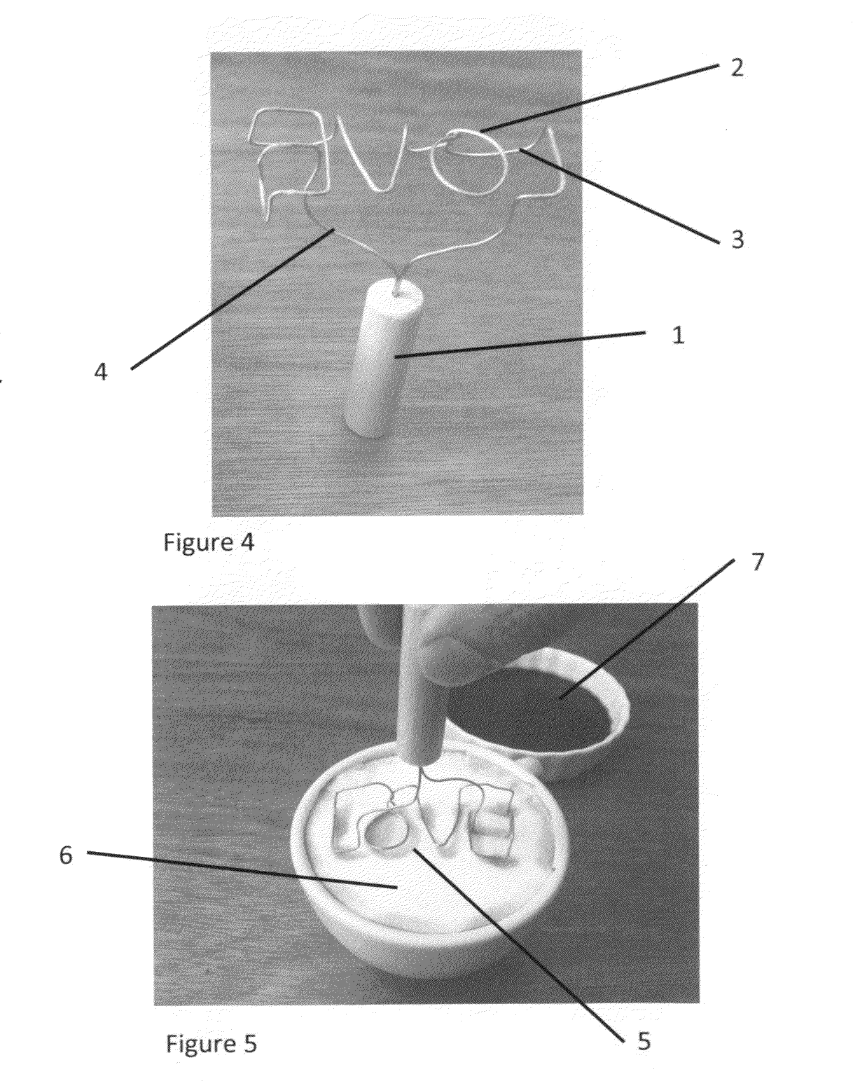

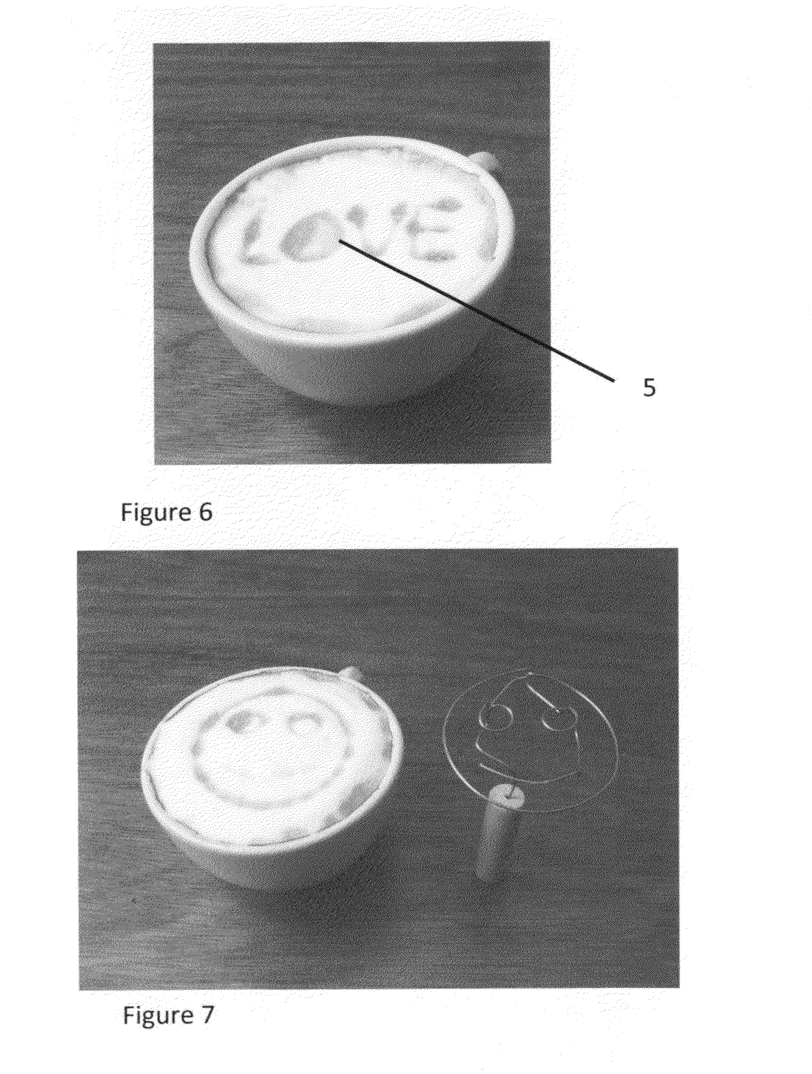

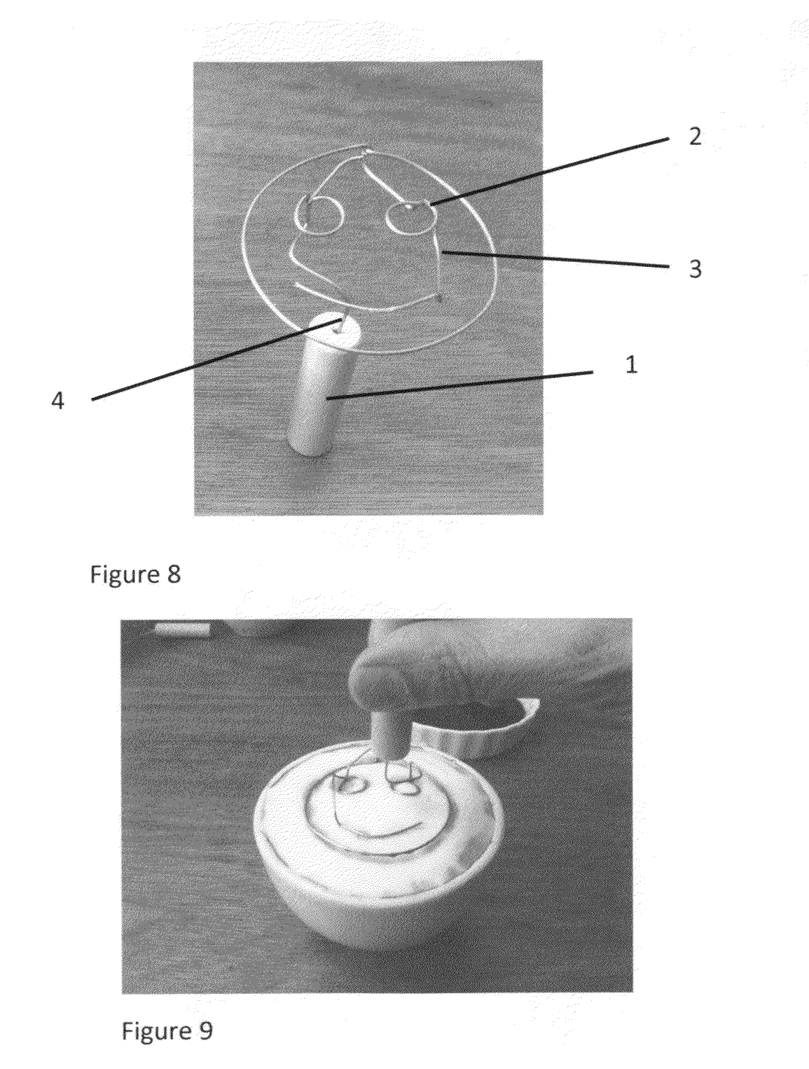

FIG. 1 is a perspective view of the stamp 1 constructed in accordance with one embodiment. The shows stamp imprints the word “Love”. The handle 2 to hold and operate the stamp has a hole 3 to connect the stamping wire 3. The stamping part is made out of food-save metal wire (stainless steel) bent according to the indented imprint. The wire of the stamp is bent in three dimensions allowing imprints of complex pictures and text that consists of multiple elements (e.g. letters, objects that are not connected to each other) in one stamping process. Sections of the wire that create an imprint arc at base level, for example the letter “L” 4, and sections that connect the “imprint” areas, such as the connecting pad 5 front the Letter L 4 to the letter O 6 are at a higher level, neither touching the coffee when loading the stamp, nor touching the surface of the milk-froth when stamping. This stamp design allows almost unlimited possibilities of creating stamps and imprints of all kind of shapes, texts, and pictures. FIG. 2 shows another stamp that follows the same design principles and process of operation. The handle 3 connects with the stamp of a smiley face, with the outer circle 7 and one eye 9 connected by section 8.

The surface of the stamp wire 1 is mechanically modified and roughened to increase the surface area. This modification increases the capability to hold more liquid (e.g. coffee), better controls the liquid, and avoids tripping when the stamp is operated. It also ensures an easier and even release of the coffee liquid into the milk froth by just touching the surface. Unlike traditional stamps, this stamp does not require pressure to create an imprint. This modification of the wire surface also allows creating different thickness, wash-out and other special effects of the imprint.

### COMPONENTS

1. Stamp that imprints the word LOVE

2. Handle to hold and operate the stamp

3. Whole in handle that connects the wire of the stamp with the handle

4. Part of the wire that imprints the letter “L”

5. Part of the wire that connects to the next letter

6. Part of the wire that imprints the letter “O”

7. Part of the wire that imprints the circle of the smiley face

8. Part of the wire that connects from the circle to one of the eyes of the imprint picture

9. Part of the wire that imprints one eye of the smiley face

10. Cup of cappuccino or café latte

11. Milk froth of a cup of café latte or cappuccino

12. The letter “L” imprinted into the milk froth after the stamping process

13. Bowl that hold coffee for the stamping process

### Operation:

The stamp 1 is being used as part of the preparation and serving of a cappuccino or café latte. After the cup of coffee is prepared and the milk froth has been poured into the cup, the user holds the stamp by its handle 2 and dips the stamp 1 into a bowl or plate of coffee 13. This applies coffee to the surface areas of the wire that are used for the imprint 4. Then, the user softly pushes the stamp 1 with the wire into the milk froth 11 by slightly touching the surface. The stamp releases the coffee into the surface of the milk froth, creating an imprint of the stamp image 12 when removing the stamp. The stamp can then be used again by dipping it into coffee and repeating the stamping process. After usage, the stamp can be easily cleaned by rinsing or immersing into water.

### Alternative Embodiments of Stamp

One embodiment of the stamp is made out of steel wire that is bent and connected to a piece of wood to hold the stamp. Other embodiments could use other materials such as copper, aluminum or other food-save materials for the stamp wire. Additional embodiments could be made using 3-D printing technology instead of bending the wire. The new 3-d printing technology allows to print 3-d object (most stamps will be 3-d for complex pictures and text) using plastic or even metal. In this case, the whole stamp including holder could be build in one step.

Another method would be injection molding of plastic.

### Alternate Embodiments of Operation

The stamp can also be used to imprint coffee drinks with other liquids, such as chocolate sauce, caramel sauce, etc. In addition, there arc many other possibilities the stamp and the associated method can be used with food that is prepared with a surface or topping that is creamy, foamy or froth like. Other examples of food could be creamy soups, milk-shakes, deserts and sauces.

I claim the invention of:

1. A stamping device to imprint a design, pattern, picture or text into the milk froth of a cup of cappuccino, café latte or other espresso drink, comprising:
a. A handle to operate the stamp;
b. A stamp attached to said handle that transfers liquid coffee into the milk froth.

2. A stamping device of claim 1 further comprising a raised stamping surface that is modeled and shaped according to the intended design, pattern or text to be imprinted into the milk froth.

3. A stamping device of claim 2 wherein said raised stamping surface is a steel wire that is bent according to the intended design, pattern or text to be imprinted into the milk froth.

4. A stamping device of claim 3 wherein said steel wire further comprising a 3-dimensional bending technique that allows using a single wire to imprint designs, pattern or text that consist of multiple, not connected, elements in one stamping process.

5. A stamping device of claim 3 wherein said steel wire further comprising a rough surface to increase the surface area and the capability to hold more liquid coffee for the stamping process.

6. A stamping device of claim 5 wherein said rough surface of steel wire further allowing better control of the applied liquid and avoidance of tripping.

7. A stamping device of claim 5 wherein said rough surface of steel wire further ensuring an even release of the coffee liquid into the milk froth by just touching the surface.

8. A stamping method to imprint a design, pattern, picture or text into the milk froth of a cup of cappuccino, café latte or other espresso drink by applying liquid coffee into the surface of milk froth, comprising the steps of:
a. Loading the stamp by dipping the stamp into liquid coffee so that only the areas that represent the imprint get immersed into the liquid coffee;
b. When stamp gets removed from the liquid coffee, a small amount of liquid coffee adheres to the surface areas of the stamp;
c. The liquid coffee gets released into the milk froth when stamp touches the surface of the milk froth;
d. The released liquid coffee imprints the design, pattern, image or text of the respective stamp into the milk froth;
e. The stamp gets removed and is ready for another stamping process.
